(19) United States
(12) Patent Application Publication
(10) Pub. No.: US 2007/0077059 A1
(43) Pub. Date: Apr. 5, 2007

(54) Multi-function image device

(75) Inventors: Laurent Denoue, Palo Alto, CA (US); Jonathan T. Foote, Menlo Park, CA (US); David M. Hilbert, Palo Alto, CA (US); Eleanor G. Rieffel, Mountain View, CA (US); Lynn D. Wilcox, Palo Alto, CA (US); Anthony E. Dunnigan, Berkeley, CA (US)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/243,603

(22) Filed: Oct. 5, 2005

(51) Int. Cl. B41J 2/435; G03B 19/00

(52) U.S. Cl. 396/429

(57) ABSTRACT

A multi-function device that prints information images onto sheets of photo-addressable media is described. The multi-function device is comprised of an image acquisition component, an image generation component, optional image transformation components and an image projector to illuminate the photo-addressable medium with the optionally transformed information images. The effects of ambient light on the photo-addressable medium are reduced by tuning the response characteristics of the photo-addressable medium to respond to the wavelength of the projected light and/or to interpose band-pass filters that reduce non-projected light incident on the photo-addressable medium. Programmable characteristics of the photo-addressable medium are adjustable to compensate for ambient light. Registration marks on the photo-addressable medium allow the alignment of the projected image with the photo-addressable medium. Additional optional image transformations are applied to adjust the size of the information image, increase clarity and the like.

### BACKGROUND OF THE INVENTION

1. Field of Invention

This invention relates to image capture, transformation and reproduction.

2. Description of Related Art

Conventional printing systems provide users with a range of printing options. For example, conventional laser printers permanently fuse particles of toner onto durable sheets of paper. These conventional laser imaging systems offer low cost archival quality printing but are not generally suitable for mobile applications due to their high power requirements. Conventional ink-jet printers use ink nozzles to eject various color inks from tanks onto sheets of paper. Although ink jet printers are typically less expensive to purchase, the cost of ink usually results in higher printing costs.

Manufacturers of some conventional printing and scanning equipment have combined the function of scanning and printing into a single multi-function device. These conventional multi-function devices incorporate optical scanning devices with ink-jet or laser printers. These conventional multi-function devices are useful in reducing the space required in small home offices. However, these multi-function devices are not well suited to portable computing environments. For example, laser based multi-function devices typically consume large quantities of power in the heating of the imaging of the image drum and in heating the image toner particles.

Ink jet based multi-function devices also consume large quantities of valuable mobile power. Moreover the resultant image quality may not be appropriate for the intended purpose.

Conventional scanners scan images by recording the reflection of light from each portion of the page. Hand scanners capture images and use software to combine the images into a single image representative of the original. Other conventional scanners move the paper over a fixed array of photo-detectors or move an array of fixed photo-detectors across the image to be scanned. Good quality scanned images are difficult to produce with conventional hand scanners due to alignment problems. Better images are produced with conventional scanners incorporating a fixed array of photo-detectors. However, conventional fixed array photo-detectors require space un-available in a typical mobile environment. Thus, a portable low-power multi-function device that does not require a large amount of space would be useful.

### SUMMARY OF THE INVENTION

Systems and method for a multi-function device that prints image information onto sheets of photo-addressable media is described. The multi-function device is comprised of an image acquisition component, an image generation component, optional image transformation components and an image projector to illuminate the photo-addressable medium with the optionally transformed image information. The effects of ambient light on the photo-addressable medium are reduced by tuning the response characteristics of the photo-addressable medium to respond to the wavelength of the projected light and/or to interpose band-pass filters that reduce non-projected light incident on the photo-addressable medium. Programmable characteristics of the photo-addressable medium are optionally be adjusted to compensate for ambient light. Registration marks on the photo-addressable medium allow the alignment of the projected image with the photo-addressable medium. Additional optional image transformations are applied to adjust the size of the information image, increase clarity and the like.

### BRIEF DESCRIPTION OF THE DRAWINGS

FIG. 1 is a first exemplary embodiment of a multi-function device according to this invention;

FIG. 2 is second exemplary embodiment of a multi-function device according to this invention;

FIG. 3 is an exemplary overview of the various image sources useable by a multi-function device according to this invention

FIG. 4 is first overview of the use of an exemplary multi-function device according to this invention;

FIG. 5 shows a third exemplary embodiment of a multi-function device according to this invention;

FIG. 6 is a first view of an exemplary photo-addressable medium according to this invention;

FIG. 7 is a second view of an exemplary photo-addressable medium according to this invention;

FIG. 8 shows the effects of ambient light on photo-addressable medium;

FIG. 9 shows one exemplary method of compensating for the effects of ambient illumination according to this invention;

FIG. 10 is a second exemplary photo-addressable medium; and

FIG. 11 is an exemplary method of providing a portable multi-function device according to this invention.

### DETAILED DESCRIPTION OF EXEMPLARY EMBODIMENTS

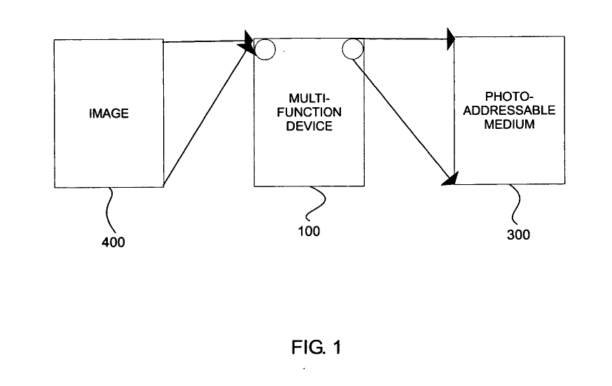

FIG. 1 is a first exemplary embodiment of a multi-function device 100 according to this invention. The acquired image information 400 is received by the multi-function device 100. The acquired image information 400 is captured using an embedded camera, retrieved from an image repository, the internet or the like.

An illumination image is created based on the acquired image information 400 and the characteristics of the photo-addressable medium upon which the image is to be printed. For example, some photo-addressable media are photo-sensitive and change their optical contrast properties in response to incident illumination. Thus, in some exemplary embodiments, the illuminated areas of the photo-addressable medium are associated with higher optical contrast than un-illuminated areas. However, other types of photo-addressable media that reduce the optical contrast of illuminated areas can also be used in the practice of this invention. Thus, for these photo-addressable media, positive or negative illumination images may be required to produce the desired result.

The positive or negative illumination image is then applied or projected onto the photo-addressable medium. In various exemplary embodiments according to this invention, the illumination image is projected onto the photo-addressable medium using the Symbol Technologies laser based micro-projector or the like. However, it will be apparent that other sources of illumination, such as, light emitting diodes (LEDs), lamps, mirrors, liquid crystal based projectors, digital light projectors (DLP) and the like may also be used alone or in combination, without departing from the scope of this invention. Thus, in another exemplary embodiment, a red laser illumination source is coaxially combined with an infra-red laser illumination source to illuminate the photo-addressable media. The combined illumination source offers the advantage of an increase in optical power for recording the illumination image onto the photo-addressable medium. In some embodiments, the illumination source and the photo-addressable medium are selected to minimize ambient light interference. In other exemplary embodiments, a band-pass filter is used to reduce the interference effects of ambient light while the illumination image is recorded onto the photo-addressable medium.

In some cases, additional steps may be required to capture an illumination image on the photo-addressable medium. For example, one type of the Fuji Xerox e-paper requires the application of a power source for a specific time period. The power source may be applied using a portable power clip that incorporates a battery and a push button activation device or the like. When the photo-addressable medium is illuminated with the illumination image, the activation device applies power, and a programming voltage is applied to the photo-addressable medium. The projected illumination image applied to the photo-addressable medium transiently changes the conductivity of portions of the photo-addressable medium cause the photo-conductive portions of the photo-addressable medium to change to a second stable state. The second stable state is associated with optical characteristics different from the first stable state. The activation device is released and the power is removed. The bi-stable photo-addressable media records the projected illumination image in the optical contrast differences of the photo-addressable medium.

In various exemplary embodiments according to this invention, the acquired image 400 is optionally transformed to compensate for skewed photo-addressable media, key-stoning, to fit the acquired image within a specified area of the photo-addressable medium or the like.

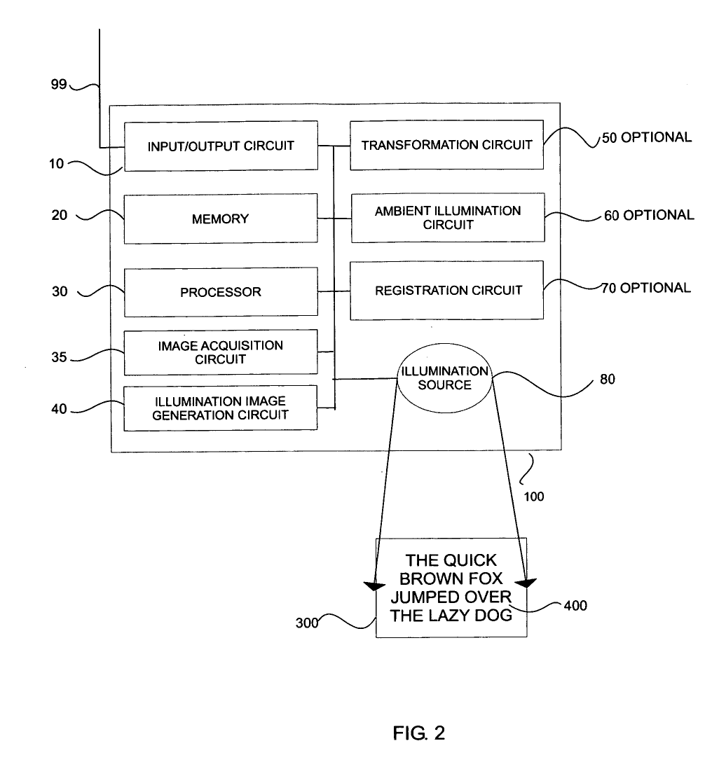

FIG. 2 is second exemplary embodiment of a multi-function device 100 according to this invention. An input/output circuit 10 is connected to a memory 20, a processor 30, an image acquisition circuit 35; an illumination image generation circuit 40, an optional transformation circuit 50, an optional ambient illumination circuit 60, an optional registration circuit 70 and an illumination source 80.

In one exemplary embodiment, the image acquisition circuit 35 is activated to acquire an image from an image source. The image source may include, but is not limited to an image repository, a disk file, an embedded or external digital camera, an image scanning device, a software application capable of producing an image file, and/or any known or later developed source of images.

The acquired image is stored in memory 20 by the processor 30. The processor 30 activates the illumination image generation circuit 40 to determine an illumination image based on the acquired image. The illumination image circuit 40 creates an image of the appropriate positive or negative contrast areas to be projected onto the photo-addressable media. The determined illumination image is then projected onto the photo-addressable media by the illumination source 80. The illumination source 80 may be a point-source such as a laser, or a non-point source such as a digital light projector (DLP) or the like. Multiple illumination sources may be combined. In various exemplary embodiments, one or more illumination sources tuned to the response characteristics of the photo-addressable media are used. For example, in one embodiment, a red laser is coaxially combined with an infrared laser to provide a combined source of illumination with increased optical power for illuminating the photo-addressable medium with the illumination image.

In various other exemplary embodiments, an optional ambient illumination circuit 60 is activated. The ambient illumination circuit 60 determines the level of ambient illumination incident on the photo-addressable medium. Compensations that adjust the illumination image and/or the programming voltage applied to the photo-addressable medium are determined. For example, the illumination source may deliver less illumination to areas of the image already illuminated by ambient light since less additional energy is required to write the image in these areas. In still other exemplary embodiments, the required programming voltage applied to the photo-addressable media 300 to write the illumination image is adjusted based on the determined ambient illumination. That is, the voltage applied to image areas already receiving ambient illumination are reduced to compensate for the additional light.

The processor 30 optionally activates the optional transformation circuit 50 to determine transformations of the illumination image. The transformations may include, but are not limited to, determining a transformation of the illumination image to align or register the projected image with the current position of the photo-addressable media. In one exemplary embodiment according to this invention, the registration marks at the top left, top right, bottom left and bottom right are identified by activating the optional registration circuit 70. The registration marks are used to determine the orientation, alignment and inclination of the surface of the photo-addressable medium. The determined orientation of the registration marks is then used to determine compensating image transformations for key-stoning or non-perpendicular projection, de-skewing and the like.

In various embodiments, the optional registration circuit 70 is comprised of a camera that captures an image of the blank photo-addressable medium. However, it will be apparent that the registration circuit may use any known or later determined method of determining the registration and alignment of the photo-addressable medium without departing from the spirit or scope of this invention.

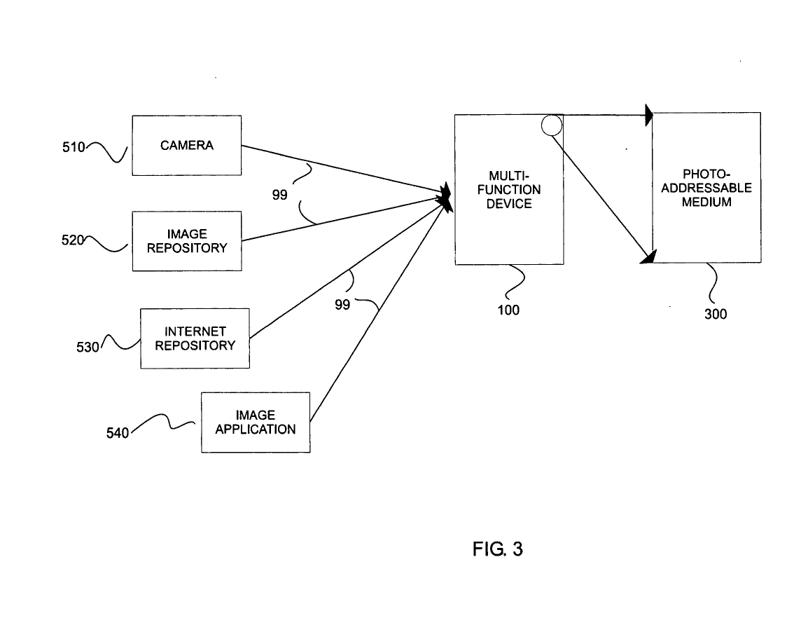

FIG. 3 is an exemplary overview of the various image sources useable by a multi-function device 100 according to this invention. In a first embodiment, a camera 510 is used to capture an image. The camera may be a digital or analog camera. The captured image is then transferred to the multi-function device 100 via a communication link 99. The communications link 99 may be a wireless link or a wired connection. Wireless links may be based on Bluetooth, WiFi, infra-red or the like. Wired links may include, but are not limited to USB, serial, parallel, Ethernet or the like. The captured image is optionally transferred to compensate for the orientation and projected onto the photo-addressable medium 300.

In various exemplary embodiments, the captured image is transformed by the multi-function device 100 to align the projected image with the photo-addressable medium. For example, registration marks may be positioned on the photo-addressable medium. A registration circuit within the multi-function device 100 detects the spatial position of the registration marks and uses the information to determine optional transformations that are applied to the image. The transformed image is then projected onto the photo-addressable medium using an illumination source. In various other exemplary embodiments, the illumination source is matched or tuned to the response characteristics of the photo-addressable medium. For example, in one embodiment, a projected image may be created by coaxially combining a red-light based micro-projector laser with an infra-red laser. A photo-addressable medium comprised of cholesteric crystals and a photo-conductor, is designed to respond to the wavelength of the combined source of illumination. The ambient light is less likely to contain both red laser and infra-red wavelengths thereby reducing ambient light effects on the photo-addressable medium.

In a second exemplary embodiment, the image is acquired from an image repository 520 containing images previously captured and downloaded from the camera 510. That is, the image repository may include an on-line photo-album or the like. An image is acquired from the image repository and transferred to the multi-function device 100. The acquired image is then optionally transformed based on the orientation of the photo-addressable media, ambient illumination, and the like. The optionally transformed image is then projected onto the photo-addressable medium 300.

In a third exemplary embodiment, the image is acquired from the internet repository 530. The internet repository 530 may be a file transfer protocol (FTP) based clip-art library, an HTML encoded web page and/or any known or later developed source of images. The image is downloaded using file transfer protocol (FTP), hypertext transfer protocol (HTTP), or the like to the multi-function device 100. The acquired image is optionally transformed and projected onto the photo-addressable medium 300 using the illumination source.

In a fourth exemplary embodiment according to this invention, the image is acquired from an image application 540. The image application 540 includes, but is not limited to, Adobe Photoshop, Corel Draw, Visio or the like. The acquired image is then transferred to the multi-function device 100, optionally transformed and applied or projected onto the photo-addressable medium 300 using an illumination source. As discussed above, various optional transformations may be applied to align the projected image with the photo-addressable medium, compensate for the effects of the ambient light and/or to perform any other useful image transformation.

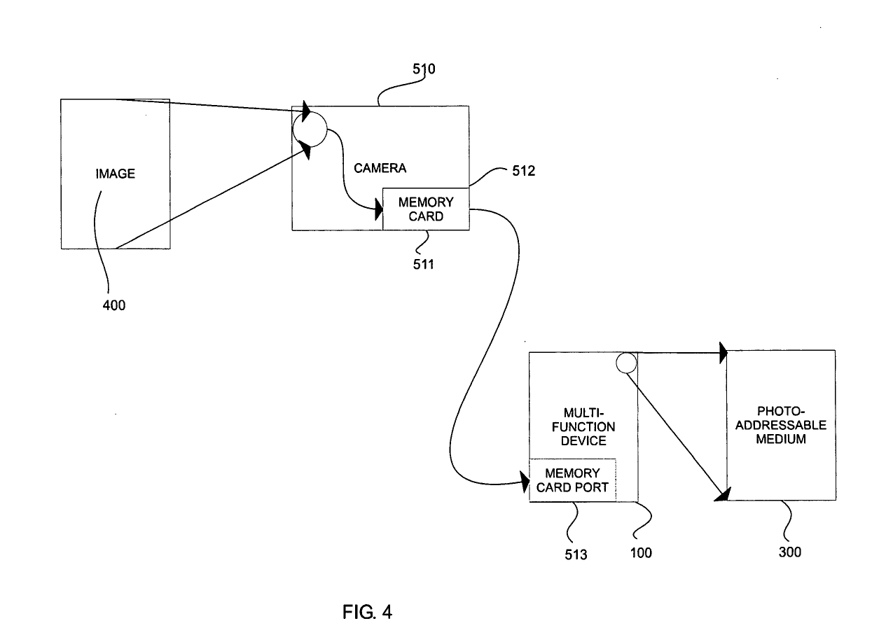

FIG. 4 is first overview of the use of an exemplary multi-function device 100 according to this invention. An image 400 is captured and stored in the memory card 511 inserted within the memory card port 512 of the digital camera 510. The user removes the memory card 511 from the camera memory card port 512. The memory card 511 containing the acquired image 400 is then inserted into the memory card port 513 of the multi-function device 100. The multi-function device 100 retrieves the acquired image 400 from the inserted memory card 511. Optional image transformations are applied to the acquired image 400 and the optionally transformed acquired image 400 is projected onto the photo-addressable medium 300. In one exemplary embodiment according to this invention, the optionally transformed acquired image is projected using an illumination source tuned to the response characteristics of the photo-addressable medium 300. In various other exemplary embodiments according to this invention, the user interface of a multi-function device provides a means for the user to select among multiple images stored on the memory card.

In various other exemplary embodiments, a programming voltage is applied to the photo-addressable medium 300 as the transformed image is projected. The programming voltage and the projected image change the optical characteristics of photo-conductive portions of the photo-addressable medium 300 based on the projected image. For example, when the programming voltage is applied to a cholesteric light sensitive layer of material sandwiched between photoconductive materials, the increased conductivity of the photo-conductive material allows power to flow to the adjacent cholesteric crystal based material. This in turn effects a state change in the cholesteric material. The states are bistable states associated with differing optical characteristics. The cholesteric material retains the new stable state after the programming voltage is removed. A facsimile of the illumination image is thereby recorded on the photo-addressable medium 300.

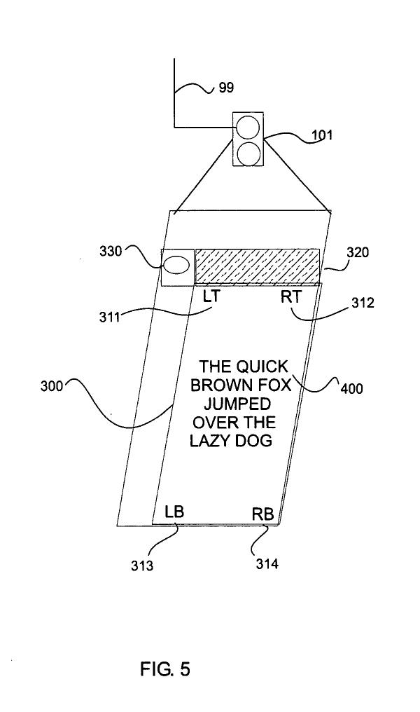

FIG. 5 shows a third exemplary embodiment of a multi-function device 101 according to this invention. The multi-function device 101 receives an acquired image over a communications link 99 from an image source. The image source may include, but is not limited to an image repository, a cellphone camera, a digital camera, an image application, a scanner and/or any other known or later developed source of images. An illumination image 400 is determined based on the acquired image. Sheets of photo-addressable media 300 are held in place on the bed of the exemplary multi-function device 101. In various embodiments, the sheets are held in place by a power-clip 320. The power clip 320 provides the programming voltage required to change the optical state of the photo-addressable medium 300. In one of the exemplary embodiments according to this invention, an activation button 330 is used to selectively apply a voltage for a requisite programming period to the photo-addressable medium 300. The programming period is based on the characteristics of the photo-addressable medium 300. The photo-addressable medium 300 optionally includes registration marks 311-314. The registration marks allow the multi-function device 101 to determine the orientation of the photo-addressable medium 300. This facilitates the application of de-skewing, key-stoning and/or any other known or later developed image transformations useful in compensating and/or aligning the illumination image 400

The illumination image 400 is projected onto the photo-addressable medium using an illumination or light source. The illumination image illuminates the photo-addressable medium 300 all at once, or via one or more point sources. For example, in one exemplary embodiment, the output of a Symbol Technologies micro-projector laser is used to rasterize or write the illumination image 400 across the photo-addressable medium 300. A programming voltage is applied to the photo-addressable medium 300 to record the projected illumination image 400. When the programming voltage is removed, the illumination image 400 is retained by the photo-addressable medium 300. It will be apparent that various types of photo-addressable medium such as Fuji Xerox e-paper may also be used without departing from the spirit or scope of this invention.

The photo-addressable medium 300 is then removed from the clip board and used much like ordinary paper. In some exemplary embodiments according to this invention, the e-paper is erased by applying second programming voltage while shielding the paper from incident light.

In still other exemplary embodiments according to this invention, the multi-function device 101 includes an ambient illumination detector. The ambient illumination detector adjusts or transforms the illumination image 400 and/or the programming voltage to compensate for the amount of ambient light. The ambient illumination detector may be a photo-detector, a CCD, a digital camera or the like.

As discussed above, the acquired image 400 is optionally transformed to de-skew and/or align the acquired image 400 with the photo-addressable medium 300. In various embodiments, image transformations are applied to compensate for any unevenness of the photo-addressable medium 300. In still other exemplary embodiments, the programming voltage is automatically applied by the multi-function device 101 without user actuation of the activation button 330. Automatically determining when to apply the programming voltage facilitates the imaging process.

In some exemplary embodiments according to this invention, an optional user interface is provided via a liquid crystal display (LCD) or other display component. The user interface facilitates the selection of discrete images from the image repository or other image source. However, it should be apparent that a voice interface and/or any known or later developed user interface may also be used to select target images for acquisition, without departing from the scope of this invention.

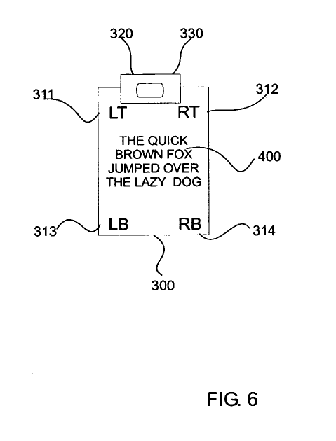

FIG. 6 is a first view of an exemplary photo-addressable medium 300 according to this invention. The photo-addressable medium 300 is comprised of a photoconductive organic layer and cholesteric liquid crystals. The cholesteric liquid crystals have conductivity variant optical qualities and optional registration marks 311-314 that indicate the orientation of the photo-addressable medium 300. The power clip 330 optionally includes an activation button 320 that applies a programming voltage to record the illumination image 400 projected onto the photo-addressable medium 300.

In one exemplary embodiment, the photo-addressable medium 300 is Fuji Xerox's e-paper based photo-addressable medium. However, it will be apparent that any paper with a photo-sensitive ink may be used in the practice of this invention. In some embodiments, the photo-addressable medium is comprised of an organic photo-conductor, cholesteric material or the like. In still other embodiments, Hydroxy Gallium Pthalocyanine is used as a charge generation material. The Fuji Xerox e-paper based photo-addressable medium is comprised of bi-stable choleristic crystals sandwiched between a photoconductive material. A programming voltage is applied to the backplane in conjunction with a projected illumination image 400. The photo-conductive material allows selective current flow based on the projected illumination image 400. The optical quality of the cholesteric crystals exposed to the higher current records the incident illumination image by changing the state of the cholesteric crystals to a second stable state associated with different optical characteristics. The cholesteric crystals are bi-stable, and remain in the second state when the power is removed.

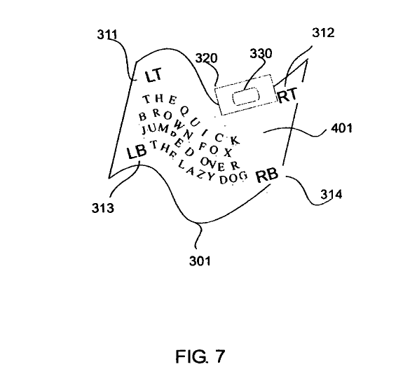

FIG. 7 is a second view of an exemplary photo-addressable medium 301 according to this invention. The photo-addressable 301 has been placed on an uneven surface. In various exemplary embodiments, the orientation of the registration marks 311-314 is used to determine appropriate image transformations to be applied to the illumination image 400. The image transformations compensate for the uneven surface, alignment, skewing and/or key-stoning problems. A transformed version of the illumination image 401 is then projected on the photo-addressable medium 301 and the programming voltage is applied. The illumination image 401 recorded onto a photo-addressable medium 301 can then be used on a flat surface without undue distortion. It will be apparent that various other transformations such as image enlargement, reduction and the like may also be performed on the illumination image 401 without departing from the spirit or scope of this invention.

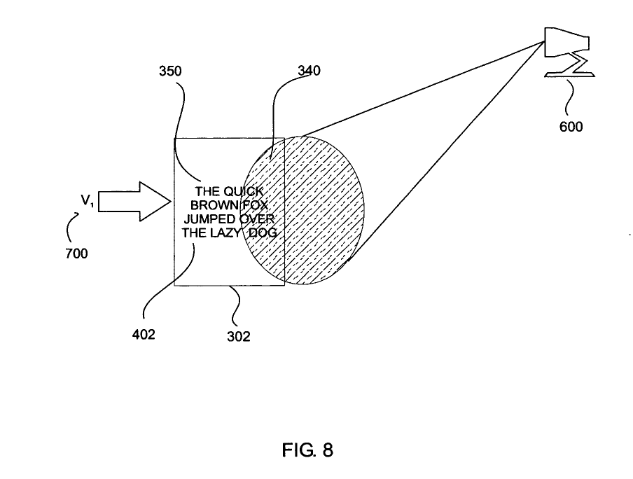

FIG. 8 shows the effects of ambient light on photo-addressable medium 302. An illumination image 402 is projected onto a photo-addressable medium 302. However, the ambient illumination 600 increases the energy incident on a glared portion 340, of the photo-addressable medium 302. A second portion 350 of the photo-addressable medium 302 receives less ambient illumination. The clarity of the illumination image 402 recorded by the photo-addressable medium 302 is affected by the incident ambient illumination making the glared area 340 of the photo-addressable medium 300 difficult to perceive.

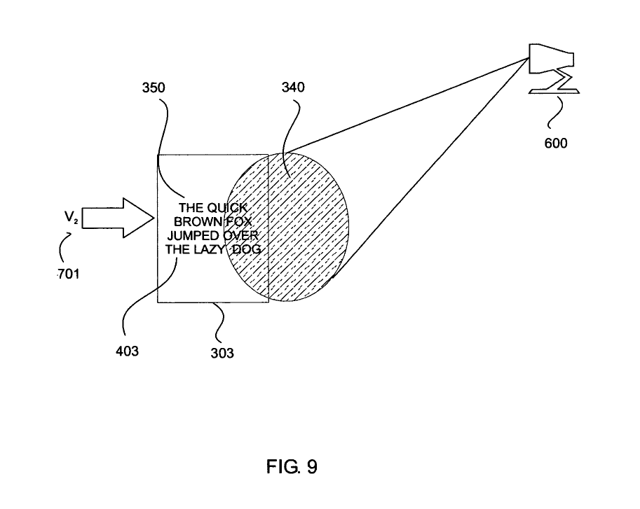

FIG. 9 shows one exemplary method of compensating for the effects of ambient illumination according to this invention. The programming voltage applied to the photo-addressable medium 303 is made pixel addressable. The ambient illumination of the photo-addressable medium 303 is determined by measurement or estimation. The energy of the ambient illumination on each pixel is adjusted to compensate for the ambient light. That is, areas of the photo-addressable medium that need to be illuminated to correctly record the image are illuminated with less projected illumination. Thus reduces the power requirements and help to reduce the effect of the ambient light incorrectly increasing the contrast of low-contrast areas of the illumination image 400.

Stronger ambient illumination creates a problem by effectively exposing all of the photo-addressable medium. That is, if the ambient illumination is strong enough, then no differentiation between high and low contrast areas will be evident and the recorded image will not be perceived. These problems are addressed by selection of the photo-addressable medium in conjunction with the type of light or illumination used to project the illumination image. For example, the photo-addressable medium may be tuned to respond to specific wavelengths of laser light not otherwise found in ambient florescent, incandescent or natural sunlight. Multiple sources of illumination may be combined and/or filters may be used to further reduce the effects.

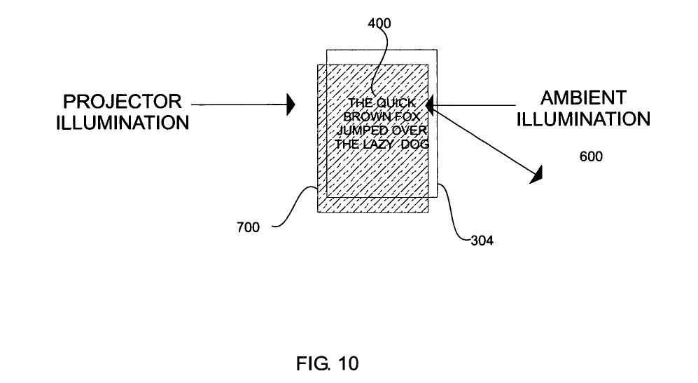

FIG. 10 is a second exemplary photo-addressable medium 304. The second exemplary photo-addressable medium 304 is tuned to respond to red laser and infra-red illumination sources. A band-pass filter 700 is interposed between the photo-addressable medium 304 and any illumination source while the programming voltage is applied. The band-pass filter 700 is tuned to pass the red laser and the infra-red illumination of the projected image 400 while blocking the ambient illumination and/or other types of energy. The resultant image is less affected by the ambient illumination.

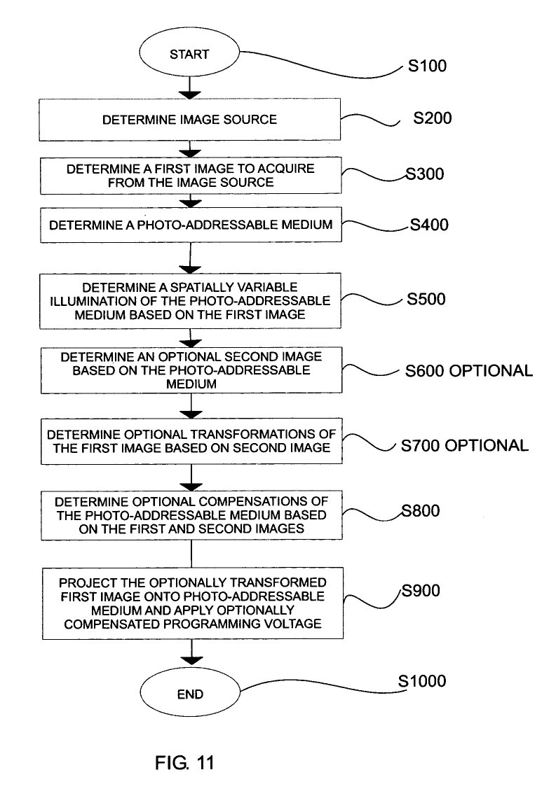

FIG. 11 is an exemplary method of providing a portable multi-function device according to this invention. The process begins at step S100 and immediately continues to step S200. In step S200, an image source is determined. The image source may be a camera, an application such as Microsoft Word, Excel, Adobe Photoshop, an image repository and/or any other known or later developed source of images. After the image source has been determined, control continues to step S300.

In step S300, a first image to be acquired from the image source is determined. The first image may be determined using a drop down dialog box, a cursor or pen gesture selection or the like. However, it should be apparent that any method of selecting a first image may be used in the practice of this invention. After the first image has been determined, control continues to step S400.

In step S400, a photo-addressable medium is determined. The photo-addressable medium may be Fuji Xerox's e-paper product, and/or any other known or later developed type of photo-addressable medium. Control then continues to step S500.

In step S500, a spatially variable illumination of the photo-addressable medium is determined based on the first image. The spatially variable illumination is provided by a point source laser such as the Symbol Technologies micro-projector laser or the like. The micro-projector laser device provides a compact and highly portable spatially variable source of illumination. However, it will be apparent that various other known or later developed types of spatially variable illumination sources may also be used without departing from the scope of this invention. After the spatially variable illumination has been determined, control continues to optional step S600.

In optional step S600, an optional second image is determined by applying the spatially variable illumination to the photo-addressable medium and storing an image of the resulting photo-addressable medium. The second image is based on the image projected onto the photo-addressable medium. The second image provides an indication of how the first image will look when recorded on the photo-addressable medium. The optional second image is recorded using a digital camera a charged coupled device (CCD) and/or any known or later developed means of capturing an image. The second image is used to determine that the projected image is mis-aligned with the optional registration marks on the photo-addressable medium. After the optional second image has been recorded, control continues to optional step S700.

In optional step S700, optional transformations of the first image are determined based on the optional second image. Thus, a mis-aligned or skewed image is corrected by transforming the image to compensate for the mis-alignment of the photo-addressable medium. Other optional transformations may be used to increase the size of text, increase the clarity of images and the like. After the optional transformations of the first image have been determined, control continues to step S800.

In step S800, optional compensations of the photo-addressable medium are determined based on the first and second images. For example, the second image may be used to detect that ambient light may wash-out the first projected image. Compensating reductions in the programming voltages applied to portions of the photo-addressable medium and the like are used to reduce the effect of the ambient light. Control then continues to step S900.

In step S900, the optionally transformed final image is projected onto the photo-addressable medium and any required programming voltages are applied. The projected image is then stably recorded onto the photo-addressable medium. In various other embodiments according to this invention, a band-pass filter is optionally interposed between the photo-addressable medium and any other source of illumination. The band-pass filter reduces the effect of the ambient illumination by selectively passing wavelengths associated with the spatially variable source of illumination.

It will be apparent that in various other exemplary embodiments according to this invention, the images may be located on the multi-function device 100, a laptop computer (not shown), an information repository (not shown) and/or any other location accessible via communications link 99.

Each of the circuits 10-70 of the multi-function device 100 described in FIG. 2 can be implemented as portions of a suitably programmed general-purpose 15 computer. Alternatively, circuits 10-70 of the multi-function device 100 outlined above can be implemented as physically distinct hardware circuits within an ASIC, or using a FPGA, a PDL, a PLA or a PAL, or using discrete logic elements or discrete circuit elements. The particular form each of the circuits 10-70 of the multi-function device 100 outlined above will take is a design choice and will be obvious and predicable to those skilled in the art.

Moreover, the multi-function device 100 and/or each of the various circuits discussed above can each be implemented as software routines, managers or objects executing on a programmed general purpose computer, a special purpose computer, a microprocessor or the like. In this case, the multi-function device 100 and/or each of the various circuits discussed above can each be implemented as one or more routines embedded in the communications network, as a resource residing on a server, or the like. The multi-function device 100 and the various circuits discussed above can also be implemented by physically incorporating the multi-function device 100 into software and/or a hardware system, such as the hardware and software systems of a web server or a client device.

As shown in FIG. 2, memory 20 can be implemented using any appropriate combination of alterable, volatile or non-volatile memory or non-alterable, or fixed memory. The alterable memory, whether volatile or non-volatile, can be implemented using any one or more of static or dynamic RAM, a floppy disk and disk drive, a write-able or rewrite-able optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

The communication links 99 shown in FIGS. 2, 3 & 5 can each be any known or later developed device or system for connecting a communication device to the multi-function device 100, including a direct cable connection, a connection over a wide area network or a local area network, a connection over an intranet, a connection over the Internet, or a connection over any other distributed processing network or system. In general, the communication links 99 can be any known or later developed connection system or structure usable to connect devices and facilitate communication.

Further, it should be appreciated that the communication links 99 can be wired or wireless links to a network. The network can be a local area network, a wide area network, an intranet, the Internet, or any other distributed processing and storage network.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A multi-function device comprising:
a portable source of spatially variable illumination;
an image acquisition circuit for acquiring image information;
an image generation circuit for generating images; and
a portable projector for projecting the image information onto a photo-addressable medium using the portable source of spatially variable illumination.

2. The multi-function device of claim 1, further comprising a registration circuit for determining characteristics of the photo-addressable medium and a transformation circuit that transforms the image information based on the characteristics.

3. The multi-function device of claim 2, in which the characteristics of the photo-addressable medium are at least one of: key-stoning, non-perpendicular projection, skew, alignment, folding, and un-evenness.

4. The multi-function device of claim 2, in which the registration circuit is at least one of: a camera, a photo-detector, a charged coupled device (CCD), and a laser barcode reader.

5. The multi-function device of claim 1, in which the image acquisition circuit is comprised of at least one of: a camera, a charged coupled device, and a photo-detector.

6. The multi-function device of claim 1, in which the projector is at least one of: a point source projector and an image source projector.

7. The multi-function device of claim 6, in which the point source projector is based on at least one of: a light emitting diode (LED), a laser, a semiconductor, an infra-red emitter, an liquid crystal display (LCD) based projector, a digital light projector (DLP) and an organic light emitting diode (OLED).

8. The multi-function device of claim 1, in which the point source is a micro-projector.

9. The multi-function device of claim 1, in which the photo-addressable medium is comprised of at least one of: a cholesteric material, a photo-sensitive ink, a photo-chromic ink, an organic photoconductor, and a Hydroxy Gallium thalocyanine charge generation material.

10. The multi-function device of claim 1, in which the photo-addressable medium is at least one of: a photo-addressable paper and Fuji Xerox photo-addressable e-paper.

11. A method for recording an image onto a photo-addressable medium comprising the steps of:
determining a first image from an image source
determining a photo-addressable medium;
determining spatially variable illumination of the photo-addressable medium based on the first image; and
projecting the first image onto the photo-addressable medium using a portable illumination source.

12. The method of claim 11, further comprising determining characteristics of the photo-addressable medium and transforming the first image based on the characteristics.

13. The method of claim 12, in which the characteristics of the photo-addressable medium are at least one of: key-stoning, non-perpendicular projection, skew, alignment, folding, un-evenness.

14. The method of claim 12, in which a registration circuit comprised of at least one of: a camera, a photo-detector, a charged coupled device (CCD), and a laser barcode reader, is used to align the first image with the photo-addressable medium.

15. A photo-addressable medium for stable recording of the image information projected by the multi-function device of claim 1.

16. The photo-addressable medium of claim 15, further comprising registration marks useable to orient the projected information image.

17. The photo-addressable medium of claim 15, in which the photo-addressable medium is comprised of a material associated with at least two stable states, each stable state associated with different optical characteristics.

18. The photo-addressable medium of claim 17, in which the optical characteristics include at least one of: high contrast and low contrast.

19. The photo-addressable medium of claim 15, in which the image information is recorded onto the material using a combination of a programming voltage and incident electromagnetic radiation.

20. The photo-addressable medium of claim 15, in which the optical characteristics of the material are set based on the incident projected image information.

21. The photo-addressable medium of claim 20, in which a programming voltage is applied to the material to record the information image.

22. The photo-addressable medium of claim 21, in which the material is comprised of at least one of: a cholesteric material, a photo-sensitive ink, a photo-chromic ink, an organic photo-conductor, and a hydroxy gallium pthalocyanine charge generation material.

23. The photo-addressable medium of claim 15, in which the photo-addressable medium responds to wavelengths of electromagnetic radiation less frequently associated with ambient light.

24. The photo-addressable medium of claim 23, in which the ambient light is at least one of florescent, incandescent, halogen and sun light.

25. A computer readable storage medium comprising computer readable program code embodied on the computer readable storage medium, the computer readable program code useable to program a computer to dynamically authenticate devices comprising the steps of:
determining a first image from an image source
determining a photo-addressable medium;
determining spatially variable illumination of the photo-addressable medium based on the first image; and
projecting the first image onto the photo-addressable medium using a portable illumination source;

26. The multi-function device of claim 1, further comprising a filter that reduces the effect of ambient light on the projected image information.

27. The multi-function device of claim 1, in which the wavelength of the portable source of spatially variable illumination is differentiable from ambient light.

28. The multi-function device of claim 1, in which the portable source of spatially variable illumination is comprised of at least two different types of illumination.

29. The multi-function device of claim 1 in which the device is combined with a portable device.

30. The multi-function device of claim 29, in which the portable device is one of: a portable phone, a mobile phone, a portable digital assistant, a camera, a computer, a laptop computer, a memory device; a memory card, a thumb-drive, and a USB drive.
